(19) United States
(12) Patent Application Publication
(10) Pub. No.: US 2026/0035033 A1
(43) Pub. Date: Feb. 5, 2026

(54) ELECTRIC POWER STEERING SYSTEM AND CONTROL METHOD THEREOF AND VEHICLE HAVING THE SAME

(71) Applicant: HL MANDO CORPORATION, Gyeonggi-do (KR)

(72) Inventors: Kyu Yeong JE, Gyeonggi-do (KR); Su Min LEE, Gyeonggi-do (KR)

(21) Appl. No.: 19/273,002

(22) Filed: Jul. 17, 2025

(30) Foreign Application Priority Data
Jul. 30, 2024 (KR) 10-2024-0100935

(51) Int. Cl. B62D 5/04

(52) U.S. Cl. CPC B62D 5/0493

(57) ABSTRACT

An electric power steering system, a control method thereof, and a vehicle equipped with same may enable two independent electronic control units to operate continuously by receiving power from another power supply if the power supply to one of the two independent electronic control units is interrupted or a failure occurs in the power supply connected to one of the two independent electronic control units.

### CROSS REFERENCE TO RELATED APPLICATION

This application claims priority from Korean Patent Application No. 10-2024-0100935, filed on Jul. 30, 2024, which is hereby incorporated by reference for all purposes as if fully set forth herein.

### TECHNICAL FIELD

An embodiment of the present disclosure relates to a power supply technology between two independent electronic control units.

### BACKGROUND

In general, an electric power steering system of a vehicle may refer to a system capable of changing a steering angle of the wheels based on a steering force (or rotational force) applied to a steering wheel by a driver.

Recently, the electric power steering system may be configured with a redundant structure utilizing two independent sensors and two independent electronic control units (ECUs) to control two independent actuators, respectively.

That is, the electric power steering system may be configured with a structure designed so that even if one electronic control unit has a problem, the other electronic control unit can operate normally.

In this case, if a failure occurs in one of the two power supply units, two sensors, and two electronic control units, the other electronic control unit can operate the connected actuator to continue steering operation.

However, if steering is continuously performed by operating one actuator, there is a problem that reliability and stability may be lowered due to output loss.

### SUMMARY

Embodiments of the present disclosure are to provide a manner capable of implementing stable power supply of two independent electronic control units.

In accordance with an aspect of the present disclosure, there may be provided an electric power steering system including a first electronic control unit configured to convert a first voltage, output from a first power supply, into a first pulse of a constant frequency, outputs the first pulse to a first steering motor, and output a voltage lower than the first voltage, output from the first power supply, to a first external sensor, a second electronic control unit configured to be converts a second voltage, output from a second power supply, into a second pulse of a constant frequency, outputs the second pulse to a second steering motor, and output a voltage lower than the second voltage, output from the second power supply, to a second external sensor, and a converter configured to, if a failure occurs in one of the first power supply or the second power supply, supply a power, supplied from another of the first power supply or the second power supply in which the failure does not occur, to one of the first electronic control unit or the second electronic control unit in which the power supply from the one of the first power supply or the second power supply is interrupted.

In accordance with another aspect of the present disclosure, there may be provided a method of controlling an electric power steering system, the method including by a first electronic control unit, converting a first voltage, output from a first power supply, into a first pulse of a constant frequency, outputting the first pulse to a first steering motor, and outputting a voltage lower than the first voltage, output from the first power supply, to a first external sensor, and by a second electronic control unit, converting a second voltage, output from a second power supply, into a second pulse of a constant frequency, outputting the second pulse to a second steering motor, and outputting a voltage lower than the second voltage, output from the second power supply, to a second external sensor, and by converter, if a failure occurs in one of the first power supply or the second power supply, supplying a power, supplied from another of the first power supply or the second power supply in which the failure does not occur, to one of the first electronic control unit or the second electronic control unit in which power supply from the one of the first power supply or the second power supply is interrupted.

In accordance with another aspect of the present disclosure, there may be provided a vehicle including a first power supply configured to supply a first direct current (DC) voltage, a first torque sensor and a first angle sensor, a first electronic control unit configured to convert the first DC voltage, output from the first power supply, into a first pulse of a constant frequency, output the first pulse to a first steering motor, and output a voltage lower than the first DC voltage, output from the first power supply, to the first torque sensor and the first angle sensor, a second power supply configured to supply a second DC voltage, a second torque sensor and a second angle sensor, a second electronic control unit configured to convert the second DC voltage, output from the second power supply, into a second pulse of a constant frequency, output the second pulses to a second steering motor, and output a voltage lower than the second DC voltage, output from the second power supply, to the second torque sensor and the second angle sensor, and a converter configured to, if a failure occurs in one of the first power supply or the second power supply, supply a power, supplied from another of the first power supply or the second power supply in which the failure does not occur, to one of the first electronic control unit or the second electronic control unit in which power supply from the one of the first power supply or the second power supply is interrupted.

According to an embodiment of the present disclosure, it is possible to provide a manner capable of implementing stable power supply of two independent electronic control units.

### BRIEF DESCRIPTION OF THE DRAWINGS

FIG. 1 is a block diagram illustrating a vehicle equipped with an electric steering system according to the present embodiment.

FIG. 2 is a block diagram illustrating an electric steering system according to one embodiment.

FIG. 3 and FIG. 4 are circuit diagrams illustrating an electric steering system according to one embodiment.

FIG. 5 is a block diagram illustrating an electric steering system according to another embodiment.

FIG. 6 and FIG. 7 are circuit diagrams illustrating an electric steering system according to another embodiment.

FIG. 8 is a block diagram illustrating an electric steering system according to another embodiment.

FIG. 9 is a flowchart illustrating a control method of an electric steering system according to the present embodiment.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

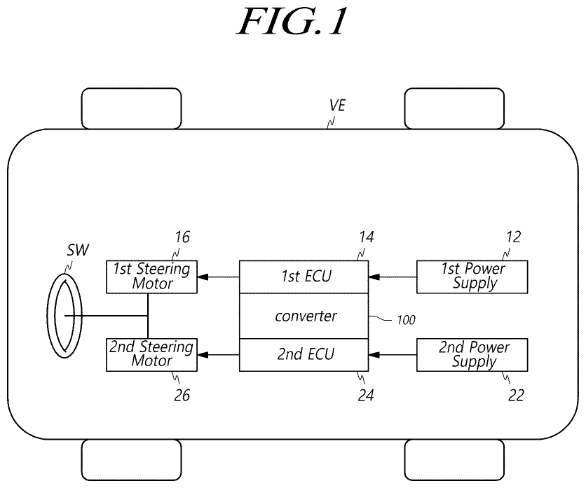

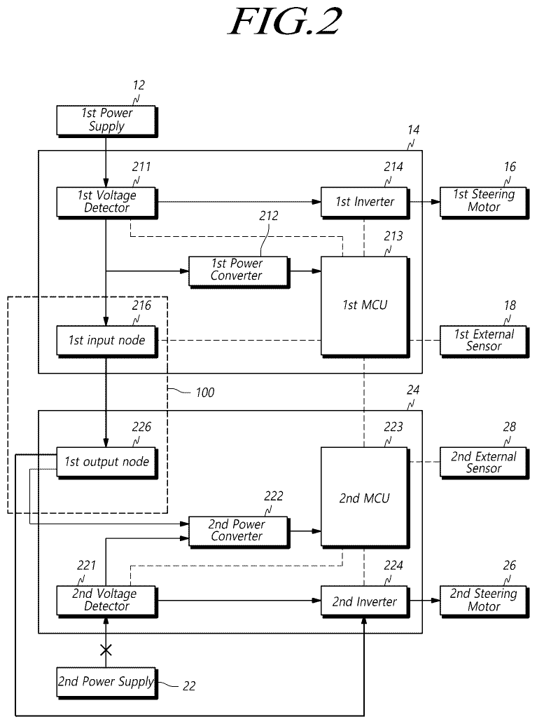

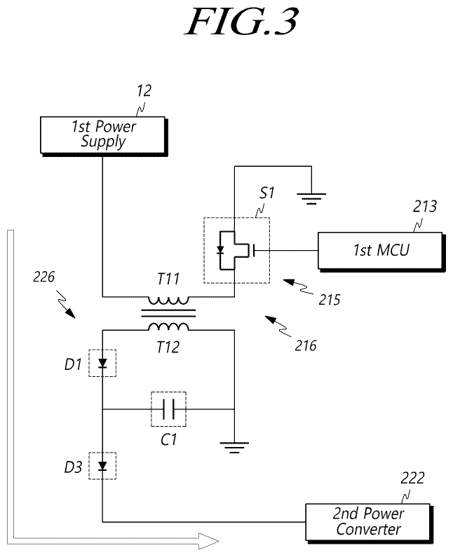

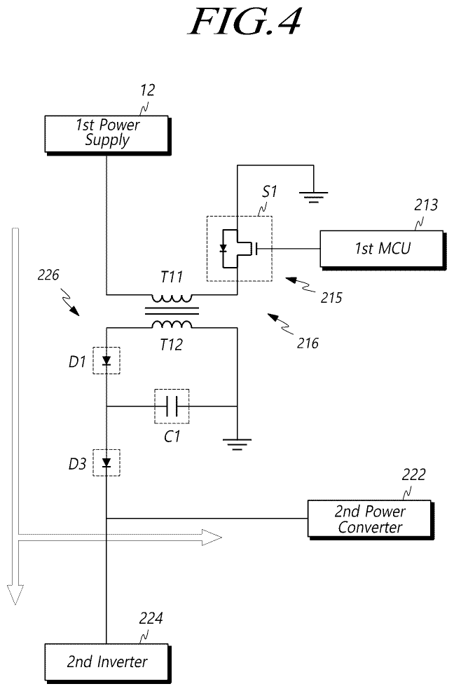

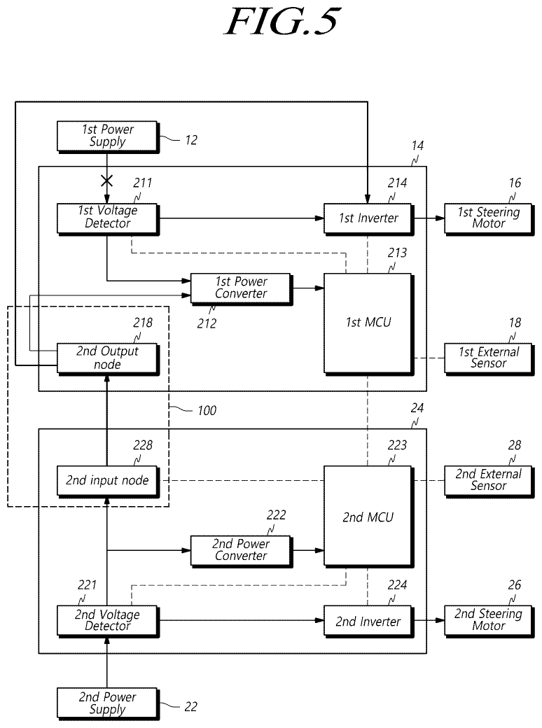

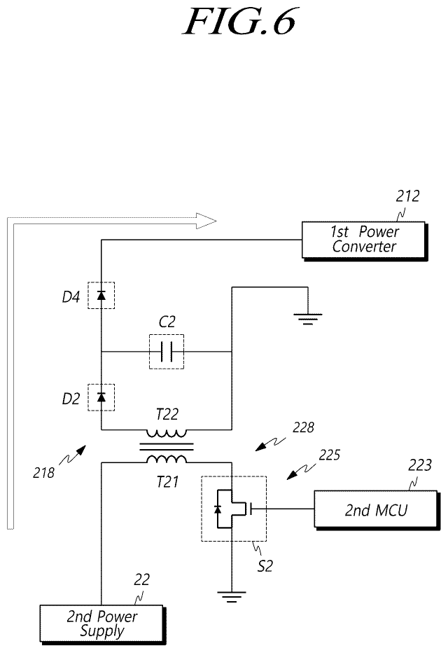

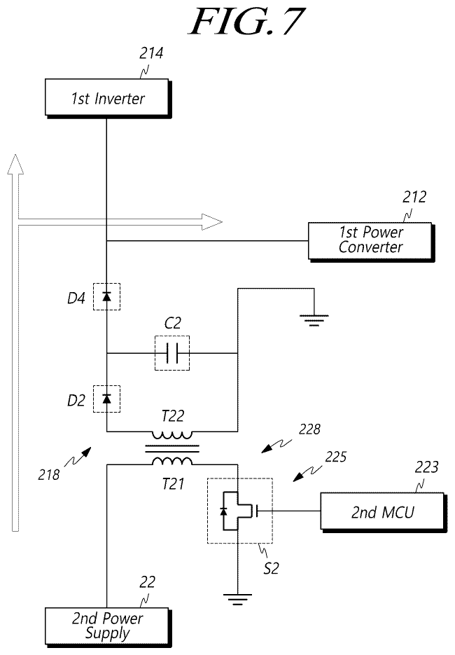

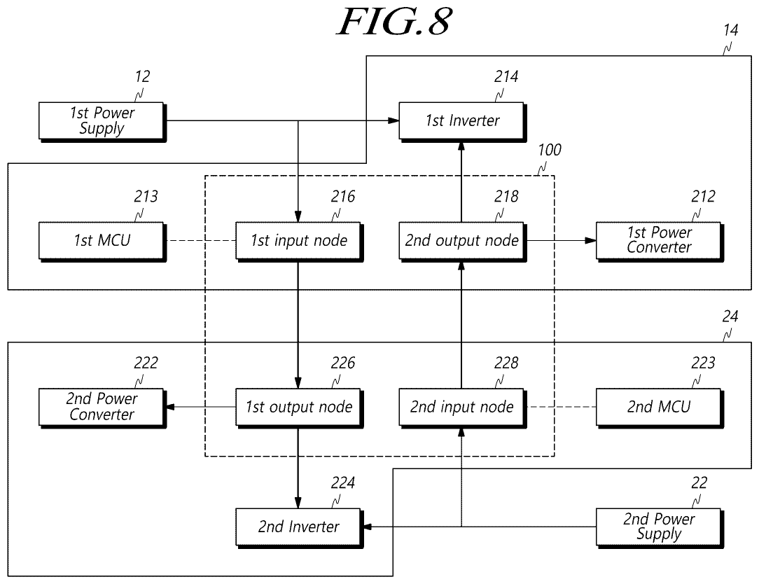

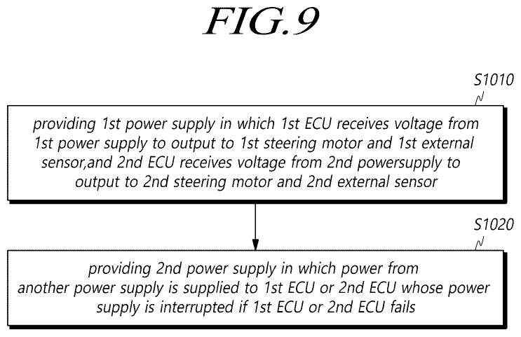

FIG. 1 is a block diagram illustrating a vehicle equipped with an electric steering system according to the present embodiment, FIG. 2 is a block diagram illustrating an electric steering system according to one embodiment, FIG. 3 and FIG. 4 are circuit diagrams illustrating an electric steering system according to one embodiment, FIG. 5 is a block diagram illustrating an electric steering system according to another embodiment, FIG. 6 and FIG. 7 are circuit diagrams illustrating an electric steering system according to another embodiment, FIG. 8 is a block diagram illustrating an electric steering system according to another embodiment, and FIG. 9 is a flowchart illustrating a control method of an electric steering system according to the present embodiment.

A vehicle VE of the present embodiment may include a first power supply 12, a second power supply 22, a first external sensor 18, a second external sensor 28, a first electronic control unit (ECU) 14, a second electronic control unit 24, and a converter 100.

Referring to FIG. 1, the vehicle VE may include: a first power supply 12 providing a DC voltage; a first external sensor 18 including a torque sensor and an angle sensor; a first electronic control unit 14 receiving a first voltage output from the first power supply 12, converting the first voltage output from the first power supply 12 into a first pulse of a constant frequency, outputting the first pulse to a first steering motor 16, and generating a voltage lower than the supplied voltage to output to the first external sensor 18; a second power supply 22 providing a DC voltage; a second external sensor 28 including a torque sensor and an angle sensor; a second electronic control unit 24 receiving a voltage output from the second power supply 22, converting the voltage into a second pulse of a constant frequency, outputting the second pulse to a second steering motor 26, and generating a voltage lower than the supplied voltage to output to the second external sensor 28; and a converter 100 for receiving a power from another power supply, if a failure occurs in either the first power supply 12 or the second power supply 22 and a power supply is interrupted, and supplying the power to the first electronic control unit 14 or the second electronic control unit 24 to which the power supply is interrupted.

The first power supply 12 may include a battery and may provide a DC voltage to the first electronic control unit 14.

The first power supply 12 may include at least one of a DC voltage power supply and an AC voltage power supply.

The first external sensor 18 may include a torque sensor which measures a torsional force applied to a rotating component such as a steering wheel SW of a vehicle, and an angle sensor which measures a position or a rotation angle of a rotating component such as a steering wheel SW.

The first external sensor 18 may be connected to the first electronic control unit 14, and may collect the steering state information and environmental information of the vehicle, and provide information to the first electronic control unit 14.

The first electronic control unit 14 may receive power from the first power supply 12, and supply power to the first steering motor 16 and the first external sensor 18.

That is, the first electronic control unit 14 may be supplied with a first voltage output from the first power supply 12, convert the first voltage output from the first power supply 12 into a first pulse of a certain frequency, output the first pulse to the first steering motor 16, and generate a voltage lower than the supplied voltage and output the voltage lower than the supplied voltage to the first external sensor 18.

The first electronic control unit 14 may electronically control the operation of the first steering motor 16 in response to the signal of the first external sensor 18.

In this case, the first electronic control unit 14 may include a first voltage detector 211 which monitors the power output from the first power supply 12 to detect whether the first power supply 12 is abnormal.

The first voltage detector 211 may monitor the power output from the first power supply 12 to detect whether the first power supply 12 is abnormal, and may provide the state information of the first power supply 12 to a first microcontroller unit (MCU) 213 or a second MCU 223.

The second power supply 22 may include a battery, and may provide a DC voltage to the second electronic control unit 24.

The second power supply (2 may include at least one of a DC voltage power supply and an AC voltage power supply.

The second external sensor 28 may include a torque sensor which measures a torsional force applied to a rotating component such as a steering wheel SW of a vehicle, and an angle sensor which measures a position or rotation angle of a rotating component such as a steering wheel SW.

The second external sensor 28 may be connected to the second electronic control unit 24, and may collect steering state information and environmental information of the vehicle and provide information to the second electronic control unit 24.

The second electronic control unit 24 may receive power from the second power supply 22, and supply power to the second steering motor 26 and the second external sensor 28.

That is, the second electronic control unit 24 may receive a voltage output from the second power supply 22, convert the voltage output from the second power supply 22 into a second pulse of a certain frequency, output the second pulse to the second steering motor 26, and generate a voltage lower than the supplied voltage and output the lowered voltage to the second external sensor 28.

The second electronic control unit 24 may electronically control the operation of the second steering motor 26 in response to the signal of the second external sensor 28.

In this case, the second electronic control unit 24 may include a second voltage detector 221 which monitors the power output from the second power supply 22 to detect whether the second power supply 22 is abnormal.

The second voltage detector 221 may monitor the power output from the second power supply 22 to detect whether the second power supply 22 is abnormal, and may provide the state information of the second power supply 22 to the first MCU 213 or the second MCU 223.

If a failure occurs in either the first power supply 12 or the second power supply 22 and the power supply is interrupted, the converter 100 may receive power from another power supply and output power to the first electronic control unit 14 or the second electronic control unit 24 whose power supply is interrupted.

In this case, the first MCU 213 of the first electronic control unit 14 or the second MCU 223 of the second electronic control unit 24 may determine whether there is an abnormality in the first power supply 12 or the second power supply 22 based on the detection signals of the first voltage detector 211 and the second voltage detector 221, and control the converter 100.

In this way, the vehicle of the present embodiment may control the converter 100 so that the two independent electronic control units may continuously operate by receiving power from another power supply in the case that the power supply to one of the two independent electronic control units is interrupted or a failure occurs in the power supply connected to one of the two independent electronic control units.

Specifically, the electric steering system of the vehicle VE may mean a system capable of changing the steering angle of the wheel based on the steering force (or rotational force) applied to the steering wheel by the driver.

The electric steering system of the vehicle VE may be configured with a redundant structure which uses two independent external sensors and two independent electronic control units (ECUs) to control two independent steering motors, respectively. Here, the steering motor may be configured as one, or may be configured with a dual-winding structure to form a redundant structure. That is, different windings may be wound on one motor core, and the current flow may be controlled by each independent electronic control unit.

In one aspect, the electric steering system of the present embodiment may include a first electronic control unit 14, a second electronic control unit 24, and a converter 100.

Referring to FIGS. 2 to 4, the electric steering system of the vehicle VE may include a first electronic control unit 14 which converts a first voltage, output from a first power supply, into a first pulse of a constant frequency, outputs the first pulse to a first steering motor 16, and outputs a voltage lower than the first voltage, output from the first power supply to a first external sensor 18; a second electronic control unit 24 which converts a second voltage, output from a second power supply, into a second pulse of a constant frequency, outputs the second pulse to a second steering motor 26, and output a voltage lower than the second voltage, output from the second power supply, to a second external sensor 28, and converter 100. In case a failure occurs in one of the first power supply 12 or the second power supply 22, the converter 100 may receive the power from another power supply and outputs a power, supplied from another of the first power supply or the second power supply in which the failure does not occur, to one of the first electronic control unit 14 or the second electronic control unit 24 whose power supply from the one of the first power supply or the second power supply is interrupted.

The first electronic control unit 14 may be supplied with the first voltage output from the first power supply 12, convert the supplied voltage into a first pulse of a certain frequency, output the first pulse to the first steering motor 16, and generate a voltage lower than the supplied voltage and outputs the lowered voltage to the first external sensor 18.

The first electronic control unit 14 may electronically control the operation of the first steering motor 16 in response to the signal of the first external sensor 18.

The second electronic control unit 24 may receive the voltage output from the second power supply 22, converts the received voltage into a second pulse of a certain frequency, output the second pulses to the second steering motor 26, and generate a voltage lower than the supplied voltage and outputs the lowered voltage to the second external sensor 28.

The electronic second control unit 24 may electronically control the operation of the second steering motor 26 in response to the signal of the second external sensor 28.

If a failure occurs in either the first power supply 12 or the second power supply 22 and the power supply is interrupted, the converter (converter unit) 100 may receive a power from the other power supply and output the power from the other power supply to the first electronic control unit 14 or the second electronic control unit 24 whose power supply is interrupted.

In one embodiment, the converter 100 may include a first primary coil T11 to which a first voltage output from a first power supply 12 is applied, and a first input node (first input unit) 216 including a first controller 215 connected to an output terminal of the first primary coil T11 to control the current flow of the first primary coil T11.

In addition, the converter 100 may include a first output node (first output unit) 226 including a first secondary coil T12 which is insulated from the first primary coil T11, and generates and outputs a second voltage supplied to the second electronic control unit 24, a first diode D1 connected to at an output terminal of the first secondary coil T12 and blocks reverse current, and a first capacitor C1 connected between an output terminal of the first diode D1 and a ground terminal of the first secondary coil T12 and maintains the output voltage smoothly.

In addition, the first electronic control unit 14 may include a first MCU 213 which controls the output voltage by controlling a duty cycle of a first switch S1 connected to the first primary coil T11 or controls the output voltage by controlling the switching frequency.

In addition, the first electronic control unit 14 may include a first power converter 212 which receives the first voltage output from the first power supply 12, generates a voltage lower than the first voltage output from the first power supply 12, and supplies the voltage to the first MCU 213 and the first external sensor 18.

In addition, the first electronic control unit 14 may include a first inverter which receives the first voltage output from the first power supply 12, converts the received voltage into a first pulse of a certain frequency, and supplies the first pulse to the first steering motor 16.

The first MCU 213 may control the output voltage of the first secondary coil T12 by controlling the duty cycle of the first switch S1 connected to the first primary coil T11, or may control the output voltage of the first secondary coil T12 by controlling the switching frequency.

For example, the first MCU 213 may control the switching period and duty cycle by turning the first switch S1 ON/OFF using a PWM controller.

The first power converter 212 may receive the first voltage output from the first power supply 12, generate a voltage lower than the first voltage output from the first power supply 12, and supply the lowered voltage to the first MCU 213 and the first external sensor 18.

The first inverter may receive the first voltage output from the first power supply 12, convert the received voltage into a first pulse of a constant frequency, and supply the first pulse to the first steering motor 16.

The converter 100 may include a first input node 216 and a first output node 226. In addition, if a failure occurs in the second power supply 22 and the power supply to the second electronic control unit 24 is interrupted, a power from the first power supply 12 may be supplied to the second electronic control unit 24 whose power supply is interrupted.

The first input node 216 may be provided in the first electronic control unit 14, and may include a primary coil T11 to which a first voltage output from the first power supply 12 is applied, and a first controller 215 connected to an output terminal of the first primary coil T11 to control the current flow of the first primary coil T11.

In addition, the first output node 226 may be equipped in the second electronic control unit 24, and may include a first secondary coil T12 which is insulated from the first primary coil T11, and generates and outputs a second voltage supplied to the second electronic control unit 24, a first diode D1 which is located at an output terminal of the first secondary coil T12 and blocks reverse current, and a first capacitor C1 which is located between an output terminal of the first diode D1 and a ground terminal of the first secondary coil T12 and smoothly maintains the output voltage.

The first controller 215 may include a first switch S1 which is turned on so that current flows in the first primary coil T11 and turned off so that current flows in the first secondary coil T12.

The first switch S1 may include a drain terminal (D), a source terminal(S), and a gate terminal (G), and may be formed of a field effect transistor (MOSFET) whose gate terminal is connected to the first MCU 213, whose source terminal is connected to the output terminal of the first primary coil T11, and whose drain terminal is connected to the ground.

The first diode D1 may be located at the output terminal of the first secondary coil T12, and may block reverse current.

In addition, the first capacitor C1 may be located between the output terminal of the first diode D1 and the ground terminal of the first secondary coil T12, and may smoothly maintain the output voltage.

In addition, the first output node 226 may include a third diode D3 which is positioned between the output terminal of the first diode D1 and the second power converter 222 or the second inverter 224, and prevents reverse flow of current output to the second power converter 222 or the second inverter 224.

The third diode D3 may be positioned between the output terminal of the first diode D1 and the second power converter 222 or the second inverter 224, and may prevent reverse flow of current output to the second power converter 222 or the second inverter 224.

For example, if the first switch S1 of the converter 100 is turned on, the input voltage of the first power supply 12 may be applied to the first primary coil T11, and current may flow through the first primary coil T11, thereby storing electric energy in the inductor. In this case, no current may flow through the first secondary coil T12.

Then, if the first switch S1 is turned off, the current flowing through the first primary coil T11 may be cut off, and the magnetic flux decreases, thereby generating an induced voltage in the first secondary coil T12.

In this case, the induced voltage may be transmitted to the output terminal through the first diode D1 and smoothly maintained by the second capacitor C2 so as to be supplied to the first power converter 212 or the first inverter 214.

Here, as shown in FIG. 3, the converter 100 may be configured as a low-power converter which lowers the input voltage and provides the lowered input voltage as an output voltage so that the second power converter 222 may receive the minimum power required to supply power to the second MCU 223 and the second external sensor 28.

Such a low-power converter may be miniaturized and lightweight, thereby reducing costs and increasing efficiency.

For example, if a failure occurs in the second power supply 22 and the power supply is interrupted, the first MCU 213 may control the first switch so that the converter 100 generates a voltage lower than the first voltage output from the first power supply 12 and output the lowered voltage to the second power converter 222, and the second power converter 222 may receive the voltage output from the converter 100 and supply it to the second MCU 223 and the second external sensor 28.

In addition, if the second power converter 222 receives the voltage output from the converter 100 and supplies it to the second MCU 223 and the second external sensor 28, the second MCU 223 may collect data from the second external sensor 28 and transmit the data to the first MCU 213.

In this way, if the power supply to one of the two independent sensors is interrupted or a failure occurs in the power supply connected to one of the two independent sensors, power may be supplied from another power supply so that the two independent sensors may continue to operate, thereby enabling accurate data collection through the two independent sensors, and even if one sensor malfunctions, the failed sensor may be replaced with the other sensor.

Meanwhile, as shown in FIG. 4, the converter 100 may be configured as a high-power converter which increases the input voltage and provides the increased input voltage as an output voltage so that the second power converter 222 can supply power to the second MCU 223 and the second external sensor 28, and the second inverter 224 may receive power and supply the power to the second steering motor 26.

Such a high-power converter may provide high output power and efficiency, thereby enhancing stability.

For example, if a failure occurs in the second power supply 22 and the power supply is interrupted, the first MCU 213 may control the first switch so that the converter 100 generates a voltage equal to the first voltage output from the first power supply 12 and outputs the generated voltage to the second power converter 222 and the second inverter 224. The second power converter 222 may receive the voltage output from the converter 100 and supply it to the second MCU 223 and the second external sensor 28. The second inverter 224 may receive the voltage output from the converter 100, convert it into a second pulse of a constant frequency, and supplies the second pulse to the second steering motor 26.

In this way, in one embodiment, even if power supply to the second electronic control unit 24 is interrupted or a failure occurs in the second power supply 22, the power can be supplied from the first power supply 12 to continuously operate two independent steering motors through two independent electronic control units.

In another aspect, the electric steering system of the present embodiment may include a first electronic control unit 14, a second electronic control unit 24, and a converter 100.

Referring to FIGS. 5 to 7, the electric steering system of the vehicle VE may include a first electronic control unit 14 which receives a voltage output from a first power supply 12, converts the received voltage into a first pulse of a constant frequency, outputs the first pulse to a first steering motor 16, and generates a voltage lower than the supplied voltage and outputs the lowered voltage to a first external sensor 18; a second electronic control unit 24 which receives a voltage output from a second power supply 22, converts the received voltage into a second pulse of a constant frequency, outputs the second pulse to a second steering motor 26, and generates a voltage lower than the supplied voltage and outputs the lowered voltage to a second external sensor 28, and a converter 100. In case a failure occurs in either the first power supply 12 or the second power supply 22 and the power supply is interrupted, the converter 100 may receive the power from another power supply and output the power to the first electronic control unit 14 or the second electronic control unit 24 whose power supply is interrupted.

The first electronic control unit 14 may be supplied with the first voltage output from the first power supply 12, convert the received voltage into a first pulse of a certain frequency, outputs the first pulse to the first steering motor 16, and generate a voltage lower than the supplied voltage and outputs the lowered voltage to the first external sensor 18.

The first electronic control unit 14 may electronically control the operation of the first steering motor 16 in response to the signal of the first external sensor 18.

The second electronic control unit 24 may receive the voltage output from the second power supply 22, convert the voltage into a second pulse of a certain frequency, output the second pulse to the second steering motor 26, and generate a voltage lower than the supplied voltage to output to the second external sensor 28.

The second electronic control unit 24 may electronically control the operation of the second steering motor 26 in response to the signal of the second external sensor 28.

In another embodiment, the converter 100 may include a second input node 228 including a second primary coil T21 to which the voltage output from the second power supply 22 is applied, and a second controller 225 connected to the output terminal of the second primary coil T21 and controlling the current flow of the second primary coil T21, and a second output node 218 including a second secondary coil T22 insulated from the second primary coil T21 and outputting a voltage supplied to the first electronic control unit 14, a second diode D2 located at the output terminal of the second secondary coil T22 and blocking reverse current, and a second capacitor C2 located between the output terminal of the second diode D2 and the ground terminal of the second secondary coil T22 and smoothly maintaining the output voltage.

In addition, the second electronic control unit 24 may include a second MCU 223 which controls the output voltage by controlling the duty cycle of a second switch S2 connected to the secondary coil T21 or controls the output voltage by controlling the switching frequency; a second power converter 222 which receives the voltage output from the second power 22 and generates a voltage lower than the voltage output from the second power 22 and supplies the lowered voltage to the second MCU 223 and the second external sensor 28; and a second inverter which receives the voltage output from the second power 22, converts it into a second pulse of a certain frequency, and supplies the second pulse to the second steering motor 26.

The second MCU 223 may control the output voltage of the second secondary coil T22 by controlling the duty cycle of the second switch S2 connected to the second primary coil T21 or control the output voltage of the second secondary coil T22 by controlling the switching frequency.

For example, the second MCU 223 may control the switching period and duty cycle by turning the second switch S2 ON/OFF using a PWM controller.

The second power converter 222 may be supplied with the voltage output from the second power supply 22, generate a voltage lower than the voltage output from the second power supply 22, and supply the lowered voltage to the second MCU 223 and the second external sensor 28.

The second inverter may receive the voltage output from the second power supply 22, convert it into a second pulse of a certain frequency, and supply the second pulse to the second steering motor 26.

The converter 100 may include a second input node 228 and a second output node 218. if a failure occurs in the first power supply 12 and the power supply to the first electronic control unit 14 is interrupted, the power from the second power supply 22 may be supplied, and power may be output to the first electronic control unit 14 whose power supply is interrupted.

The second input node 228 may be provided in the second electronic control unit 24, and may include a second primary coil T21 to which voltage output from the second power supply 22 is applied, and a second controller 225 connected to the output terminal of the second primary coil T21 to control the current flow of the second primary coil T21.

In addition, the second output node 218 may be equipped in the first electronic control unit 14, and may include a second secondary coil T22 which is insulated from the second primary coil T21, and generates and outputs a voltage supplied to the first electronic control unit 14, a second diode D2 which is located at the output terminal of the second secondary coil T22 and blocks reverse current, and a second capacitor C2 which is located between the output terminal of the second diode D2 and the ground terminal of the second secondary coil T22 and smoothly maintains the output voltage.

The second controller 225 may include a second switch S2 which is turned on so that current flows in the second primary coil T21 and turned off so that current flows in the second secondary coil T22.

The second switch S2 may include a drain terminal (D), a source terminal(S), and a gate terminal (G), and may be formed of a field effect transistor (MOSFET) whose gate terminal is connected to the second MCU 223, whose source terminal is connected to the output terminal of the second primary coil T21, and whose drain terminal is connected to the ground.

The second diode D2 may be located at the output terminal of the second secondary coil T22, and may block reverse current.

In addition, the second capacitor C2 may be located between the output terminal of the second diode D2 and the ground terminal of the second secondary coil T22, and may smoothly maintain the output voltage.

In addition, the second output node 218 may be located between the output terminal of the second diode D2 and the first power converter 212 or the first inverter 214, and may include a fourth diode D4 for preventing reverse flow of current output to the first power converter 212 or the first inverter 214.

The fourth diode D4 may be located between the output terminal of the second diode D2 and the first power converter 212 or the first inverter 214, and may prevent the reverse flow of the current output to the first power converter 212 or the first inverter 214.

For example, if the second switch S2 of the converter 100 is turned on, the input voltage of the second power supply 22 may be applied to the second primary coil T21, and current may flow through the second primary coil T21, thereby storing electric energy in an inductor. In this case, current may not flow through the second secondary coil T22.

In addition, if the second switch S2 is switched to be turned off, the current flowing in the second primary coil T21 may be cut off and the magnetic flux may decrease, so that an induced voltage may be generated in the second secondary coil T22.

In this case, the induced voltage may be transmitted to the output terminal through the second diode D2 and smoothly maintained by the second capacitor C2 so as to be supplied to the first power converter 212 or the first inverter 214.

Here, as illustrated in FIG. 6, the converter 100 may be configured as a low-power converter that lowers the input voltage and provides the lowered input voltage as an output voltage so that the first power converter 212 can receive the minimum power required to supply power to the first MCU 213 and the first external sensor 18.

Such low-power converters may be miniaturized and lightweight, thereby reducing costs, and increasing efficiency.

For example, if a failure occurs in the first power supply 12 and the power supply is interrupted, the second MCU 223 may control the second switch so as for the converter 100 to generate a voltage lower than the voltage output from the second power supply 22 and to outputs it to the first power converter 212. The first power converter 212 may receive the voltage output from the converter 100 to supply to the first MCU 213 and the first external sensor 18.

In addition, if the first power converter 212 receives the voltage output from the converter 100 and supplies it to the first MCU 213 and the first external sensor 18, the first MCU 213 may collect data of the first external sensor 18 and transmit the data to the second MCU 223.

Here, the first MCU and the second MCU may collect data of the first external sensor or the second external sensor and share the collected data with each other.

In this way, if the power supply to one of the two independent sensors is interrupted or a failure occurs in the power supply connected to one of the two independent sensors, power may be supplied from another power supply so that the two independent sensors can continuously operate, thereby enabling accurate data to be collected through the two independent sensors. In addition, if one sensor malfunctions, the failed sensor may be replaced with another sensor.

Meanwhile, as shown in FIG. 7, the converter 100 may be configured as a high-power converter which increases the input voltage and provides the increased input voltage as an output voltage so as for the first power converter 212 to supply power to the first MCU 213 and the first external sensor 18, The first inverter 214 may receive power to supply power to the first steering motor 16.

Such a high-power converter can provide high output power and efficiency, and may increase stability.

For example, if a failure occurs in the first power supply 12 and power supply is interrupted, the second MCU 223 may control the second switch so as for the converter 100 to generate a voltage equal to the voltage output from the second power supply 22 and output it to the first power converter 212 and the first inverter 214. The first power converter 212 may receive the voltage output from the converter 100 to supply to the first MCU 213 and the first external sensor 18. The first inverter 214 may receive the voltage output from the converter 100, convert the voltage output from the converter 100 into a first pulse of a constant frequency, and supply the first pulse to the first steering motor 16.

In another embodiment, if the power supply to the first electronic control unit 14 is interrupted or the first power supply 12 fails, power may be supplied from the second power supply 22 to continuously operate two independent steering motors through two independent electronic control units.

In another embodiment, as shown in FIG. 8, the converter 100 may include a first input node 216, a first output node 226, a second input node 228, and a second output node 218.

That is, the converter 100 may include a primary coil T11 to which a first voltage output from the first power supply 12 is applied, and a first input node 216 including a first controller 215 connected to the output terminal of the first primary coil T11 to control the current flow of the first primary coil T11.

In addition, the converter 100 may include a first output node 226 including a first secondary coil T12 which is insulated from the first primary coil T11, and generates and outputs a second voltage supplied to the second electronic control unit 24, a first diode D1 located at the output terminal of the first secondary coil T12 and blocking reverse current, and a first capacitor C1 located between the output terminal of the first diode D1 and the ground terminal of the first secondary coil T12 and maintaining a smooth output voltage.

In addition, the converter 100 may include a second primary coil T21 to which a voltage output from a second power supply 22 is applied, and a second input node 228 including a second controller 225 connected to an output terminal of the second primary coil T21 to control the current flow of the second primary coil T21.

In addition, the converter 100 may include a second output node 218 including a second secondary coil T22 which is insulated from the second primary coil T21 and outputs a voltage supplied to the first electronic control unit 14, a second diode D2 located at the output terminal of the second secondary coil T22 and blocking reverse current, and a second capacitor C2 located between the output terminal of the second diode D2 and the ground terminal of the second secondary coil T22 and maintaining a smooth output voltage.

Here, the first input node 216 and the first output node 226 may be formed by low-power converters, and the second input node 228 and the second output node 218 may be formed by high-power converters, Alternatively, the first input node 216 and the first output node 226 may be formed by high-power converters, and the second input node 228 and the second output node 218 may be formed by low-power converters.

Alternatively, the first input node 216, the first output node 226, the second input node 228, and the second output node 218 may all be formed by low-power converters or high-power converters.

In another aspect, the control method of the electric power steering system of the present embodiment may include a first power supply step and a second power supply step. The first power supply step is supplying the first power. And the second power supply step is supplying the second power.

Referring to FIG. 9, a control method of an electric power steering system of a vehicle VE may include a first power supply step in which a first electronic control unit 14 receives a voltage output from a first power supply 12, converts it into a first pulse of a constant frequency, outputs the first pulse to a first steering motor 16, generates a voltage lower than the supplied voltage, and outputs the lowered voltage to a first external sensor 18, and a second electronic control unit 24 receives a voltage output from a second power supply 22, converts it into a second pulse of a constant frequency, outputs the second pulse to a second steering motor 26, generates a voltage lower than the supplied voltage, and outputs the lowered voltage to a second external sensor 28 (S1010).

In addition, the control method of the electric power steering system of the vehicle VE may include a second power supply step S1020 in which the converter 100 receives power from another power supply and outputs the power to the first electronic control unit 14 or the second electronic control unit 24 whose power supply is interrupted if a failure occurs in either the first power supply 12 or the second power supply 22 (S1020).

In the first power supply step (S1010), the first electronic control unit 14 may receive the first voltage output from the first power supply 12, convert the received voltage into a first pulse of a certain frequency, and output the first pulse to the first steering motor 16. In addition, in the first power supply step (S1010), a voltage lower than the supplied voltage may be generated and output to the first external sensor 18, and the second electronic control unit 24 may receive the voltage output from the second power supply 22, convert the supplied voltage into a second pulse of a certain frequency, output the second pulse to the second steering motor 26, and generate a voltage lower than the supplied voltage to outputs to the second external sensor 28.

In addition, in the second power supply step S1020, if a failure occurs in either the first power supply 12 or the second power supply 22 and the power supply is interrupted, the converter 100 may receive the power from another power supply to output to the first electronic control unit 14 or the second electronic control unit 24 whose power supply is interrupted.

In this case, the second power supply step (S1020) may further include a step in which the first MCU 213 controls the first switch so as for the converter 100 to generate a voltage lower than the first voltage output from the first power supply 12 and outputs the lowered voltage to the second power converter 222 if a failure occurs in the second power supply 22 and the power supply is interrupted.

In addition, the second power supply step (S1020) may include a step in which the second power converter 222 receives the voltage output from the converter 100 and supplies the received voltage to the second MCU 223 and the second external sensor 28.

That is, in the second power supply step (S1020), if a failure occurs in the second power supply 22 and power supply is interrupted or stopped, the converter 100 may generate a voltage lower than the first voltage output from the first power supply 12 and outputs the lowered voltage to the second power converter 222, and the first MCU 213 controls the first switch so as for the second power converter 222 to receive the voltage output from the converter 100 and supply the received voltage to the second MCU 223 and the second external sensor 28.

In this case, the converter 100 may be configured as a low-power converter which lowers the input voltage and provides the lowered voltage as an output voltage so that the second power converter 222 can receive the minimum power required to supply power to the second MCU 223 and the second external sensor 28.

The low-power converters may be miniaturized and lightweight, thereby reducing costs, and increasing efficiency.

Alternatively, the second power supply step (S1020) may further include a step in which the first MCU 213 controls the first switch so as for the converter 100 to generate a voltage equal to the first voltage output from the first power supply 12 and outputs the generated voltage to the second power converter 222 and the second inverter 224 if the second power supply 22 fails and the power supply is interrupted.

In addition, the second power supply step (S1020) may further include a step in which the second power converter 222 receives the voltage output from the converter 100 and supplies the received voltage to the second MCU 223 and the second external sensor 28.

In addition, the second power supply step (S1020) may include a step in which the second inverter 224 receives the voltage output from the converter 100, converts the received voltage into a second pulse of a certain frequency, and supplies the second pulse to the second steering motor 26.

That is, in the second power supply step (S1020), if a failure occurs in the second power supply 22 and the power supply is interrupted, the first MCU 213 may control the first switch so as for the converter 100 to generate a voltage equal to the first voltage output from the first power supply 12 and output the generated voltage to the second power converter 222 and the second inverter 224. In addition, the second power supply step (S1020) may be configured such that the second power converter 222 receives the voltage output from the converter 100 and supplies to the second MCU 223 and the second external sensor 28. The second inverter 224 may receive the voltage output from the converter 100, convert the received voltage into a second pulse of a certain frequency, and supply the second pulse to the second steering motor 26.

In this case, the converter 100 may be configured as a high-output converter capable of increasing the input voltage and providing the increased input voltage as an output voltage so that the second power converter 222 can supply power to the second MCU 223 and the second external sensor 28, and the second inverter 224 can receive power to supply power to the second steering motor 26)

The high-output converter may provide high output power and efficiency, and can increase stability.

Alternatively, the second power supply step (S1020) may include a step in which the second MCU 223 controls the second switch so as for the converter 100 to generate a voltage lower than the voltage output from the second power supply 22 and outputs the lowered voltage to the first power converter 212 if a failure occurs in the first power supply 12 and the power supply is interrupted; and a step in which the first power converter 212 receives the voltage output from the converter 100 and supplies the received voltage to the first MCU 213 and the first external sensor 18.

That is, in the second power supply step (S1020), if a failure occurs in the first power supply 12 and power supply is interrupted, the converter 100 may generate a voltage lower than the voltage output from the second power supply 22 and outputs the lowered voltage to the first power converter 212, and the second MCU 223 may control the second switch so as for the first power converter 212 to receive the voltage output from the converter 100 and supply it to the first MCU 213 and the first external sensor 18.

Here, the converter 100 may be configured as a low-power converter which lowers the input voltage and provides the lowered voltage as an output voltage so that the first power converter 212 can receive the minimum power required to supply power to the first MCU 213 and the first external sensor 18.

Such low-power converters can be miniaturized and lightweight, thereby reducing costs, and increasing efficiency.

Alternatively, the second power supply step (S1020) may further include a step in which the second MCU 223 controls the second switch so that the converter 100 generates a voltage equal to the voltage output from the second power supply 22 and outputs to the first power converter 212 and the first inverter 214 if the first power supply 12 fails and the power supply is interrupted.

In addition, the second power supply step (S1020) may further include a step in which the first power converter 212 receives the voltage output from the converter 100 and supplies the received voltage to the first MCU 213 and the first external sensor 18.

In addition, the second power supply step (S1020) may include a step in which the first inverter 214 receives the voltage output from the converter 100, converts the received voltage into a first pulse of a certain frequency, and supplies the first pulse to the first steering motor 16.

That is, in the second power supply step (S1020), if a failure occurs in the first power supply 12 and power supply is interrupted, the second MCU 223 may control the second switch so that the converter 100 generates a voltage equal to the voltage output from the second power supply 22 and outputs to the first power converter 212 and the first inverter 214, and the first power converter 212 receives the voltage output from the converter 100 and supplies it to the first MCU 213 and the first external sensor 18, and the first inverter 214 receives the voltage output from the converter 100 and converts the received voltage into a first pulse of a constant frequency and supplies the first pulse to the first steering motor 16.

Here, the converter 100 may be formed as a high-power converter capable of increasing the input voltage and provides the increased input voltage as an output voltage so that the first power converter 212 can supply power to the first MCU 213 and the first external sensor 18, and the first inverter 214 can receive power to supply power to the first steering motor 16.

Such a high-power converter can provide high output power and efficiency, and can increase stability.

In this way, in the present embodiment, if the power supply to one of the two independent electronic control units is interrupted or a failure occurs in the power supply connected to one of the two independent electronic control units, power can be supplied from another power supply so that the two independent electronic control units can operate continuously.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

The scope of protection of the present disclosure should be interpreted by the claims below, and all technical ideas within the scope equivalent thereto should be interpreted as being included in the scope of rights of the present disclosure.

What is claimed is:

1. An electric power steering system comprising:
a first electronic control unit configured to convert a first voltage, output from a first power supply, into a first pulse of a constant frequency, output the first pulse to a first steering motor, and output a voltage lower than the first voltage, output from the first power supply, to a first external sensor;
a second electronic control unit configured to convert a second voltage, output from a second power supply, into a second pulse of a constant frequency, output the second pulse to a second steering motor, and output a voltage lower than the second voltage, output from the second power supply, to a second external sensor; and
a converter configured to, if a failure occurs in one of the first power supply or the second power supply, supply a power, supplied from another of the first power supply or the second power supply in which the failure does not occur, to one of the first electronic control unit or the second electronic control unit in which power supply from the one of the first power supply or the second power supply is interrupted.

2. The electric power steering system of claim 1, wherein the converter includes:
a first input node including a first primary coil to which the first voltage output from the first power supply is applied, and a first controller connected to an output terminal of the first primary coil to control a current flow of the first primary coil; and
a first output node including a first secondary coil which is insulated from the first primary coil and is configured to output the second voltage supplied to the second electronic control unit, a first diode connected to an output terminal of the first secondary coil, and a first capacitor connected between an output terminal of the first diode and a ground terminal of the first secondary coil.

3. The electric power steering system of claim 2, wherein the first controller includes a first switch configured to be turned on to allow current to flow through the first primary coil and to be turned off to allow current to flow through the first secondary coil.

4. The electric power steering system of claim 3, wherein the first electronic control unit includes a first micro controller unit (MCU) configured to control an output voltage by controlling a duty cycle of the first switch or by controlling a switching frequency.

5. The electric power steering system of claim 4, wherein the first electronic control unit includes:
a first power converter configured to be supplied with the first voltage output from the first power supply, generate the voltage lower than the first voltage output from the first power supply, and supply the voltage lower than the first voltage output from the first power supply to the first MCU and the first external sensor; and
a first inverter configured to be supplied with the first voltage output from the first power supply, convert the first voltage output from the first power supply into the first pulse of the constant frequency, and supply the first pulse to the first steering motor.

6. The electric power steering system of claim 5, wherein the converter includes:
a second input node including a second primary coil to which the second voltage output from the second power supply is applied, and a second controller connected to an output terminal of the second primary coil to control a current flow of the second primary coil; and
a second output node including a second secondary coil which is insulated from the second primary coil and is configured to output the first voltage supplied to the first electronic control unit, a second diode connected to an output terminal of the second secondary coil, and a second capacitor connected between an output terminal of the second diode and a ground terminal of the second secondary coil.

7. The electric power steering system of claim 6, wherein the second controller includes a second switch configured to be turned on to allow current to flow through the second primary coil and to be turned off to allow current to flow through the second secondary coil.

8. The electric power steering system of claim 7, wherein the second electronic control unit includes a second MCU configured to control an output voltage by controlling a duty cycle of the second switch or by controlling a switching frequency.

9. The electric power steering system of claim 8, wherein the second electronic control unit includes:
a second power converter configured to be supplied with the second voltage output from the second power supply, generate the voltage lower than the second voltage output from the second power supply, and supply the voltage lower than the second voltage output from the second power supply to the second MCU and the second external sensor; and
a second inverter configured to be supplied with the second voltage output from the second power supply, convert the second voltage output from the second power supply into a pulse of a constant frequency, and supply the pulse to the second steering motor.

10. The electric power steering system of claim 9, wherein:
the first MCU is configured to, in a case that a failure occurs in the second power supply, control the first switch such that the converter outputs the voltage lower than the first voltage output from the first power supply to the second power converter, and
the second power converter is configured to, in the case that the failure occurs in the second power supply, supply a voltage, supplied from the converter, to the second MCU and the second external sensor.

11. The electric power steering system of claim 9, wherein:
the first MCU is configured to, in a case that a failure occurs in the second power supply, control the first switch such that the converter outputs a voltage equal to the first voltage output from the first power supply to the second power converter and the second inverter,
the second power converter is configured to, in the case that the failure occurs in the second power supply, supply a voltage, supplied from the converter, to the second MCU and the second external sensor, and
the second inverter is configured to, in the case that the failure occurs in the second power supply, convert the voltage, supplied from the converter, into the pulse of the constant frequency, and supply the pulse to the second steering motor.

12. The electric power steering system of claim 9, wherein:
the second MCU is configured to, in a case that a failure occurs in the first power supply, control the second switch such that the converter outputs the voltage lower than the second voltage, output from the second power supply, to the first power converter, and
the first power converter is configured to, in the case that the failure occurs in the first power supply, supply the voltage, output from the converter, to the first MCU and the first external sensor.

13. The electric power steering system of claim 12, wherein the first MCU and the second MCU are configured to collect and share data from the first external sensor and/or the second external sensor.

14. The electric power steering system of claim 9, wherein:
the second MCU is configured to, in a case that a failure occurs in the first power supply, control the second switch such that the converter outputs a voltage equal to the second voltage output from the second power supply to the first power converter and the first inverter,
the first power converter is configured to, in the case that the failure occurs in the first power supply, supply the voltage, output from the converter, to the first MCU and the first external sensor, and
the first inverter is configured to, in the case that the failure occurs in the first power supply, convert the voltage, output from the converter, into a pulse of a constant frequency, and supplies the pulse to the first steering motor.

15. A method of controlling an electric power steering system, the method comprising:
by a first electronic control unit, converting a first voltage, output from a first power supply, into a first pulse of a constant frequency, outputting the first pulse to a first steering motor, and outputting a voltage lower than the first voltage, output from the first power supply, to a first external sensor;
by a second electronic control unit, converting a second voltage, output from a second power supply, into a second pulse of a constant frequency, outputting the second pulse to a second steering motor, and outputting a voltage lower than the second voltage, output from the second power supply, to a second external sensor; and
by a converter, if a failure occurs in one of the first power supply or the second power supply, supplying a power, supplied from another of the first power supply or the second power supply in which the failure does not occur, to one of the first electronic control unit or the second electronic control unit in which power supply from the one of the first power supply or the second power supply is interrupted.

16. The method of claim 15, wherein the supplying of the power to the one of the first electronic control unit or the second electronic control unit includes, if a failure occurs in the second power supply:
by a first microcontroller unit (MCU), controlling a first switch such that the converter outputs the voltage lower than the first voltage, output from the first power supply, to a second power converter; and
by second power converter, supplying the voltage, output from the converter, to a second MCU and the second external sensor.

17. The method of claim 15, wherein the supplying of the power to the one of the first electronic control unit or the second electronic control unit includes, if a failure occurs in the first power supply:
by a second MCU, controlling a second switch such that the converter outputs a voltage lower than the second voltage, output from the second power supply, to a first power converter; and
by the first power converter, supplying the voltage, output from the converter, to a first MCU and the first external sensor.

18. A vehicle comprising:
a first power supply configured to supply a first direct current (DC) voltage;
a first torque sensor and a first angle sensor;
a first electronic control unit configured to convert the first DC voltage, output from the first power supply, into a first pulse of a constant frequency, output the first pulse to a first steering motor, and output a voltage lower than the first DC voltage, output from the first power supply, to the first torque sensor and the first angle sensor;
a second power supply configured to supply a second DC voltage;
a second torque sensor and a second angle sensor;
a second electronic control unit configured to convert the second DC voltage, output from the second power supply, into a second pulse of a constant frequency, output the second pulse to a second steering motor, and output a voltage lower than the second DC voltage, output from the second power supply, to the second torque sensor and the second angle sensor; and
a converter configured to, if a failure occurs in one of the first power supply or the second power supply, supply a power, supplied from another of the first power supply or the second power supply in which the failure does not occur, to one of the first electronic control unit or the second electronic control unit in which power supply from the one of the first power supply or the second power supply is interrupted.

19. The vehicle of claim 18, wherein the converter includes:
a first input node including a first primary coil to which the first DC voltage output from the first power supply is applied, and a first controller connected to an output terminal of the first primary coil to control a current flow of the first primary coil; and
a first output node including a first secondary coil which is insulated from the first primary coil and is configured to output the second DC voltage supplied to the second electronic control unit, a first diode connected to an output terminal of the first secondary coil, and a first capacitor connected between an output terminal of the first diode and a ground terminal of the first secondary coil.

20. The vehicle of claim 18, wherein the converter includes:
a second input node including a second primary coil to which the second DC voltage output from the second power supply is applied, and a second controller connected to an output terminal of the second primary coil to control a current flow of the second primary coil; and
a second output node including a second secondary coil which is insulated from the second primary coil and is configured to output the first voltage supplied to the first electronic control unit, a second diode connected to an output terminal of the second secondary coil, and a second capacitor connected between an output terminal of the second diode and a ground terminal of the second secondary coil.
